(19) United States
(12) Patent Application Publication
(10) Pub. No.: US 2020/0199404 A1
(43) Pub. Date: Jun. 25, 2020

(54) AMINO-FUNCTIONAL SILSESQUIOXANE COPOLYMER COATINGS

(71) Applicant: 3M INNOVATIVE PROPERTIES COMPANY, St. Paul, MN (US)

(72) Inventors: Jitendra S. RATHORE, Woodbury, MN (US); Suman K. PATEL, Woodbury, MN (US); David W. MEITZ, St. Paul, MN (US); Reema CHATTERJEE, Woodbury, MN (US)

(21) Appl. No.: 16/622,351

(22) PCT Filed: Jun. 13, 2018
(86) PCT No.: PCT/IB2018/054330

§ 371 Date: Dec. 13, 2019

Related U.S. Application Data
(60) Provisional application No. 62/519,035, filed on Jun. 13, 2017.

(51) Int. Cl. C09D 183/08; C08G 77/04; G09F 3/02

(52) U.S. Cl. CPC C09D 183/08; G09F 3/02; C08G 77/045

(57) ABSTRACT

Coatings containing a silsesquioxane copolymer are described. The silsesquioxane copolymer comprises amino-functional repeat units and non-functional repeat units. Methods for preparing such coatings using hydrolysable silanes are also described. Articles incorporating such coatings, including retroreflective articles are also described.

### FIELD

The present disclosure relates to coatings containing a silsesquioxane copolymer. The silsesquioxane copolymer comprises amino-functional repeat units and non-functional repeat units. Methods for preparing such coatings and their uses are also described.

### SUMMARY

Briefly, in one aspect, the present disclosure provides a coating comprising an amino-functional silsesquioxane having amino-functional repeat units and non-functional repeat units. The non-functional repeat units comprise non-functional groups selected from the group consisting of alkyl-groups and aryl-groups consisting of hydrogen and carbon.

In some embodiments, the amino-functional silsesquioxane is the hydrolyzed product of at least one amino-functional, hydrolysable silane according to formula:

R_{AM}—Si—(R)₃

and at least one non-functional, hydrolysable silane according to formula:

R_{NF}—Si—(R)₃

wherein:

R_{AM} is an amino-functional group; and

R_{NF} is a non-functional group selected from the group consisting of alkyl-groups and aryl-groups consisting of hydrogen and carbon; and

each R is, independently, a hydroxyl group or a hydrolysable group.

In some embodiments, at least one amino-functional group is an aminoalkyl-group, e.g., an aminoalkyltrihydroxy silane or an aminoalkyltrialkoxy silane. In some embodiments, at least one amino-functional, hydrolysable silane is selected from the group consisting of aminopropylsilanetriol, aminopropyltrimethoxysilane, aminopropyltriethoxysilane, and combinations thereof. In some embodiments, at least one amino-functional group is an aminoalkylaminoalkyl-group, e.g., at least one amino-functional, hydrolysable silane may be selected from the group consisting of aminopropylaminoethyltrimethoxysilane, aminopropylaminoethyltriethoxysilane, aminoethylaminopropyltrimethoxysilane, aminoethylaminopropyltriethoxysilane, and combinations thereof.

Independently from the selection of the amino-functional, hydrolysable silane, in some embodiments, the non-functional, hydrolysable silane is selected from the group consisting of an alkyltrihydroxy silane, an akyltrialkoxy silane, an aryltrihydroxy silane, an aryltrialkoxy silane, and combinations thereof. In some embodiments, the non-functional silane may be selected from the group consisting of ethyltrialkoxy silane, phenyltrialkoxy silane, and combinations thereof.

Independently from the selection of the amino-functional silsesquioxane and the non-functional hydrolysable silane, in some embodiments, a ratio MR_{NF} is defined as MR_{NF}=M_{NF}/(M_{NF}+M_{AM}), where M_{NF} moles of the nonfunctional silane(s) and M_{AM} is the moles of amino-functional silane(s); and wherein MR_{NF} is between 0.05 and 0.5, inclusive.

In another aspect, the present disclosure provides an article comprising a substrate and the coating according to any of the embodiments of the present disclosure bonded to a surface of the substrate. In some embodiments, the substrate comprises a retroreflective sheeting. In some embodiments, the article further comprises an ink bonded to the coating.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 illustrates an exemplary article comprising a coating according to some embodiments of the present disclosure.

FIG. 2 illustrates an exemplary retroreflective article comprising a coating according to some embodiments of the present disclosure.

### DETAILED DESCRIPTION

There are many applications where the properties of a substrate are enhanced by applying coatings to create a functional layer. For example, in many applications only some of the required properties are provided by selecting an appropriate substrate such as a polymeric film or a metal foil. However, often the substrate itself is deficient in one or more desired characteristics such as durability (e.g., solvent or abrasion resistance) or adhesion (e.g., print receptivity or interlayer adhesion). Many coatings have been developed to create layers on such substrates in order to enhance the properties lacking in the substrate itself.

Individual coatings may be suitable for use only with selected substrates, and each coating tends to present its own trade-offs in performance improvements and limitations. Therefore, there is an on-going need for new coatings to meet new applications or requirements, or which provide a more desirable balance of performance enhancements and limitations.

Functional silanes, such as epoxy-, vinyl-, and acryl-functional silanes have been used to prepare coatings. However, the functionality of such silanes was typically selected such that the functional groups reacted with materials later applied to the coating such as adhesives and inks. In contrast, the coatings of the present disclosure include amino-functional groups. Without wishing to be bound by any theory, it is believed that the hydrogen bonding between the amino-groups within the coating itself provides the desired benefits.

Coatings prepared from amino-functional silsequioxanes having only amino-functional repeat units may be used as adhesion promoting layers. However, such coatings may remain tacky after curing and may increase in tackiness due to the ingress of moisture. In other instances, such coatings are hard and brittle due to the extensive hydrogen bonding through the amino-groups.

The present inventors discovered that incorporating non-functional repeat units into an amino-functional silsesquioxane coating could improve certain properties making them suitable for use in a variety of applications. For example, more pliable and durable coatings could be obtained. Surprisingly, the present inventors also discovered that the introduction of even low levels of non-functional repeat units could provide a substantial improvement in solvent resistance. As a result, such modified coatings were found to exhibit good adhesion to substrates, and to provide benefits such as solvent resistance, abrasion resistance, and ink receptivity, e.g., UV inkjet ink receptivity.

A silsesquioxane (“SSQ”) is an organosilicon compound with an empirical formula RSiO_{3/2}; where Si is elemental silicon, O is oxygen, and R is a non-functional group or a functional group. Generally, SSQs adopt a cage-like or polymeric structure with Si—O—Si linkages. Each Si group is bonded to three oxygen groups, with each of these oxygen groups bonded to a further Si group. The fourth group bonded to each silicon group—the R-group—may be independently selected.

Silsesquioxanes can be prepared as the hydrolyzed product of hydrolysable silanes. In order to form the silsesquioxane structure, the hydrolysable silanes have the general formula:

R1-Si—(R2)₃

wherein: R1 is a functional group or a non-functional group; and

R2 is a hydroxyl group or a hydrolysable group, wherein each R2 may be independently selected.

As used herein, a hydrolysable group is one that reacts in the presence of water having a pH of 1 to 10 under conditions of atmospheric pressure. The hydrolysable group is converted to a hydroxyl group, resulting in Si—OH groups. Typical hydrolysable groups include, but are not limited to, hydrogen and halo-groups that are directly bonded to a silicon atom, and alkoxy-, aryloxy-, aralkyloxy-, alkaryloxy-, acyloxy-, (meth)acryloyloxy-groups where the oxygen of the oxy-group is directly bonded to a silicon atom.

The term “halo-groups” refers to a halogen atom such as bromo-, iodo-, fluoro-, or chloro-groups. In some embodiments, chloro-groups may be preferred.

The term “alkoxy” refers to a monovalent group having an oxygen singular bonded directly to an alkyl group. Generally, the alkyl group may be linear or branched. In some embodiments, the alkyl group contains 1 to 10, e.g., 1 to 6, or even 2 to 4 carbon atoms. The term “aryloxy” refers to a monovalent group having an oxygen singular bonded directly to an aryl group. In some embodiments, suitable aryl groups have 6 to 12 carbon atoms such as, for example, a phenyl group.

The terms “aralkyloxy” and “alkaryloxy” refer to a monovalent group having an oxygen singular bonded directly to an aralkyl group or an alkaryl group, respectively. In some embodiments, the alkyl group contains 1 to 10, e.g., 1 to 6, or even 2 to 4 carbon atoms. In some embodiments, the aryl group has 6 to 12 carbon atoms such as, for example, a phenyl group.

The term “acyloxy” refers to a monovalent group of the formula —O(CO)R3 where R3 is alkyl, aryl, aralkyl, or alkaryl. Suitable alkyl R3-groups include those having 1 to 10 carbon atoms, 1 to 6 carbon atoms, or 1 to 4 carbon atoms. Suitable aryl groups include those having 6 to 12 carbon atoms. Suitable aralkyl and alkaryl R3-groups include those having an alkyl group with 1 to 10 carbon atoms, e.g., 1 to 6 carbon atoms, or 1 to 4 carbon atoms; and an aryl having 6 to 12 carbon atoms. The term “(meth)acryloyloxy group” includes acryloyloxy groups (—O—(CO)—CH═CH2) and methacryloyloxy groups (—O—(CO)—C(CH3)=CH2).

In the presence of water, the hydrolysable groups are converted to silanol groups (Si—OH). These silanol groups can then condense over time to form the siloxane bonds (Si—O—Si) of the silsesquioxane polymer. The condensation reaction can be accelerated with known acid/base catalysts.

The copolymers of the present disclosure include repeat units where R1 comprises at least one amino-functional group. In some embodiments, the amino-functional group is a terminal primary amine group. For example, in some embodiments, the amino-functional group is an aminoalkyl group such as an aminoethyl- or aminopropyl-group. In some embodiments, the amino-functional group includes a terminal primary amine group and a secondary amino-group. For example, in some embodiments, the amino-functional group is an aminoalkylaminoalkyl-group, such as an aminoethylaminopropyl- or aminopropylaminoethyl-group.

Silsesquioxanes with amino-functional repeat units can be prepared by hydrolyzing amino-containing, hydrolysable silanes. Suitable silanes include those having a terminal primary amine group, for example, aminoalkyltrialkoxy silanes such as aminopropyltrimethoxysilane and aminopropyltriethoxysilane. In some embodiments, both primary and secondary amine groups may be present, for example aminoalkylaminoalkyltrialkoxy silanes such as aminopropylaminoethyltrimethoxysilane, aminopropylaminoethyltriethoxysilane, aminoethylaminopropyltrimethoxysilane, and aminoethylaminopropyltriethoxysilane.

The copolymers of the present disclosure include repeat units where R1 is a non-functional group. As used herein, “non-functional group” refers to alkyl-groups and aryl-groups consisting of hydrogen and carbon. Suitable alkyl-groups include straight chain and branched alkyl groups such as methyl, ethyl, propyl, and butyl groups, as well as alkyl-groups with aryl substituents, i.e., aralkyl-groups. Suitable aryl-groups include phenyl groups, as well as aryl-groups with alkyl substituents, i.e., alkaryl-groups.

Generally, the amino-functional silsequioxanes of the present disclosure may be prepared by mixing one or more amino-functional silanes having the general formula:

R_{AM}—Si—(R)₃

with one or more non-functional silanes having the general formula:

R_{NF}—Si—(R)₃

in the presence of water, wherein:

R_{AM} is an amino-functional group; and

R_{NF} is a non-functional group as defined herein; and

each R is, independently, a hydroxyl group, or a hydrolysable group.

The resulting condensation reaction will result in the silsequioxane structure with functional repeat units having pendant amino functionality, and non-functional repeat units.

The relative amount of the non-functional repeat units can be determined as the ratio (MR_{NF}) of moles of the nonfunctional silane(s) (M_{NF}) over the total moles of the amino-functional silane(s) (M_{AM}) and the non-functional silane(s) (M_{NF}), i.e.,

MR_{NF}=M_{NF}/(M_{NF}+M_{AM}).

The lower limit of MR_{NF} primarily depends on the amount of disruption desired in the hydrogen-bonding produced by the amino groups. The present inventors discovered that even small amounts of non-functional silanes can yield significant improvements in performance. In some embodiments, the molar ratio of non-functional repeat units, MR_{NF}, is at least 0.05, e.g., at least 0.07.

The upper limit of MR_{NF} primarily depends on the minimum amount of desired hydrogen-bonding produced by the amino groups. The present inventors discovered that even with high amounts of non-functional silanes, significant benefits from the remaining amino-functional repeat units can be obtained. In some embodiments, the molar ratio of non-functional repeat units, MR_{NF}, is no greater than 0.5, e.g., no greater than 0.4, or even no greater than 0.2.

In some embodiments, the molar ratio of non-functional repeat units, MR_{NF}, is between 0.05 and 0.5, e.g., between 0.05 and 0.4, between 0.05 and 0.2, or even between 0.07 and 0.2, wherein all ranges include their endpoints.

Certain embodiments of the present disclosure are illustrated in the following examples.

TABLE 1
Summary of materials used in the preparation of the examples.

| Name | Description | Trade Name and Source |
|---|---|---|
| AM-Silane-1 | aminopropyltrimethoxysilane | Gelest, Inc., Morrisville, |
| | | Pennsylvania |
| AM-Silane-2 | aminopropyltriethoxysilane | Gelest, Inc. |
| AM-Silane-3 | aminopropylsilanetriol | DYNASYLAN HYDROSIL 1151 |
| | (40 weight percent in water) | Evonik Industries |
| NF-Silane-1 | phenyltrimethoxysilane | Gelest, Inc. |
| NF-Silane-2 | ethyltrimethoxysilane | Gelest, Inc. |

AM-Silane-1 and AM-Silane-2 were amino-functional silanes with three alkoxy groups. AM-Silane-3 was an amino-functional silane with three hydroxyl groups. NF-Silane-1 and -2 were non-functional silanes with three alkoxy groups.

Coating-1 was prepared by mixing 18 g (0.1 moles) of AM-Silane-1 with 7.2 g of distilled water for ten minutes. NF-Silane-1 (1.8 g, 0.009 moles) was then added to the mixture. The resulting silsequioxane had a calculated molar ratio, MR_{NF} of 0.08.

Coating-2 was prepared by mixing 22.1 g (0.1 moles) of AM-Silane-2 with 7.2 g of distilled water for fifteen minutes. NF-Silane-2 (1.8 g, 0.015 moles) was then added to the mixture. The resulting silsequioxane had a calculated molar ratio, MR_{NF} of 0.13.

Coating-3 was prepared by mixing 22.2 g (0.1 moles) of AM-Silane-2 with 7.2 g of distilled water for ten minutes. NF-Silane-1 (1.8 g, 0.009 moles) was then added to the mixture. The resulting silsequioxane had a calculated molar ratio, MR_{NF} of 0.08.

Coating-4 was prepared by mixing 20.0 g of AM-Silane-3 (0.058 moles as a 40 wt. % solution) was mixed with NF-Silane-1 (8 g, 0.04 moles). A nonionic surfactant (0.08 g of TERGITOL TMN-10 from Dow Chemical Company, said to be a 90 wt. % branched secondary alcohol ethoxylate in water) was then added to the mixture. The resulting silsequioxane had a calculated molar ratio, MR_{NF} of 0.4.

Coating-REF-1 was prepared by mixing 50 g (0.28 moles) of AM-Silane-1 with 16 g of distilled water for ten minutes. As this coating did not include a non-functional silane, the resulting silsequioxane had a molar ratio, MR_{NF} of 0.

Coating-REF-2 was prepared by mixing 50 g (0.28 moles) of AM-Silane-2 with 16 g of distilled water for ten minutes. As this coating did not include a non-functional silane, the resulting silsequioxane had a molar ratio, MR_{NF} of 0.

Test Substrate B was prepared by coating a solvent-based blue ink onto extruded, polycarbonate, cube corner, retroreflective sheeting. The blue ink comprised UCAR VAGH vinyl chloride/vinyl acetate resin (Dow Chemical Company), PARALOID B-66 thermoplastic acrylic resin (Rohm & Hass), blue pigment, and solvent.

Test Substrate G was prepared by coating a solvent-based green ink onto extruded, polycarbonate, cube corner, retroreflective sheeting. The green ink comprised UCAR VAGH vinyl chloride/vinyl acetate resin (Dow Chemical Company), green pigment, and solvent.

Coating Procedure. The sample coatings were applied to the test substrates using a Number 8 Mayer bar. Drying/curing of the coating was performed at 110° C. for sixty seconds in an oven equipped with solvent exhaust.

Solvent-Resistance Procedure. An approximately 3.8 cm (1.5 inch) by 25 cm (10 inch) strip of the coated substrate was applied to the center of an aluminum panel. The panel was placed in a GARDCO Model D10V Linear Motion Washability and Wear Tester. A bristle brush on a metal support weighing about 450 g was used.

About 10 milliliters of methyl ethyl ketone (MEK) were applied to four layers of paper towel, which were taped to the bristle brush. The Tester was used to rub the sample on the panel with the MEK-soaked towels. The appearance of the sample was visually evaluated after a specified number of double rubs; where a “double rub” consists of a pass along the length of the sample and back. A coating with good solvent resistance will exhibit little or no ink removal from the coated sample, and will show little or no ink transfer to the paper towels.

Pencil Hardness Procedure. The hardness of the cured films was determined according to ASTM D3363-05(2011)e2 “Standard Test Method for Film Hardness by Pencil Test” (available from ASTM International, West Conshohocken, Pa.). The apparatus used was an ELCOMETER 3086 Scratch Boy (obtained from Elcometer Instruments Limited, MI). Pencil hardness was measured by moving a pencil of a designated hardness grade across the test surface and thereafter looking at the surface under a microscope to find if the surface was scratched. This process is repeated moving from the softest grade to hardest grade pencil (i.e., 9B, 8B, 7B, 6B, 5B, 4B, 3B, 2B, B, HB, F, H, 2H, 3H, 4H, 5H, 6H, 7H, 8H, 9H). The sample was designated a hardness value corresponding to the hardest pencil that did not microscopically scratch the surface of the sample.

Reference Example REF-1 was an uncoated sample of Substrate-B. REF-1 exhibited very poor solvent resistance. After only five double rubs, the ink was almost completely removed and transferred to the paper towels.

Example EX-1 was prepared by applying Coating-1 to Substrate B according to the Coating Procedure. Even after 20 double rubs according to the Solvent-Resistance Procedure, very little ink was removed from the coated sample. Coating-1 had a hardness grade of “B” as determined by the Pencil Hardness Procedure. A replicate sample was prepared and tested according to the Solvent-Resistance Procedure. Almost no ink was removed after 40 double rubs.

Example EX-2 was prepared by applying Coating-2 to Substrate B according to the Coating Procedure. Sample EX-2 exhibited excellent solvent resistance, as very little ink was removed from the coated sample after 20 double rubs according to the Solvent-Resistance Procedure. This example was repeated, with similar results. Coating-2 had a hardness grade of “B” as determined by the Pencil Hardness Procedure. A replicate sample was prepared and tested according to the Solvent-Resistance Procedure. Almost no ink was removed after 40 double rubs.

Example EX-3 was prepared by applying Coating-3 to Substrate B according to the Coating Procedure. Very little ink was removed from the coated sample after 20 double rubs according to the Solvent-Resistance Procedure. This example was repeated, with similar results. Coating-3 had a hardness grade of “B” as determined by the Pencil Hardness Procedure.

Example EX-4 was prepared by applying Coating-4 to Substrate G according to the Coating Procedure. Very little ink was removed from the coated sample after 10 and 20 double rubs according to the Solvent-Resistance Procedure. More ink removal occurred after 50 rubs, but it was still far superior to the results obtained after only 5 rubs with the uncoated reference sample. Coating-4 had a hardness grade of “B” as determined by the Pencil Hardness Procedure.

Comparative Example CE-1 was prepared by applying Coating-REF-1 to Substrate B according to the Coating Procedure. The hardness could not be determined as Coating-REF-1 remained tacky. After 10 double rubs according to the Solvent-Resistance Procedure, a substantial amount of ink was removed from the substrate and transferred to the paper towel.

Comparative Example CE-2 was prepared by applying Coating-REF-2 to Substrate B according to the Coating Procedure. The hardness could not be determined as Coating-REF-2 remained tacky. After 10 double rubs according to the Solvent-Resistance Procedure, a substantial amount of ink was removed from the substrate and transferred to the paper towel.

TABLE 2
Summary of test results.

| | AM- | NF- | | | Pencil | |
|---|---|---|---|---|---|---|
| Sample | Silane | Silane | MR_{NF} | Substrate | Hardness | Ink Removal |
| Ref | — | — | — | B | — | Poor - removal after 5 double rubs |
| EX-1 | 1 | 1 | 0.08 | B | B | Excellent - up to 40 double rubs |
| EX-2 | 2 | 2 | 0.13 | B | B | Excellent - up to 40 double rubs |
| EX-3 | 2 | 1 | 0.08 | B | B | Excellent - up to 20 double rubs |
| EX-4 | 3 | 1 | 0.4 | G | B | Excellent - up to 20 double rubs |
| | | | | | | Very good - up to 50 double rubs |
| CE-1 | 1 | — | 0 | B | tacky | Poor - removal after 10 double rubs |
| CE-2 | 2 | — | 0 | B | tacky | Poor - removal after 10 double rubs |

The coatings of the present disclosure may be suitable for a wide variety of applications. Generally, the coating will be applied to a substrate to enhance desired properties such as solvent resistance or durability. In some embodiments, the coating may be suitable as a primer for adhering other coatings, e.g., adhesives, to the underlying substrate. In some embodiments, the coatings may provide ink receptivity and ink adhesion. In some embodiments, the coating may be suitable for providing solvent resistance, and other coatings may be applied to provide other features such as ink receptivity or adhesion.

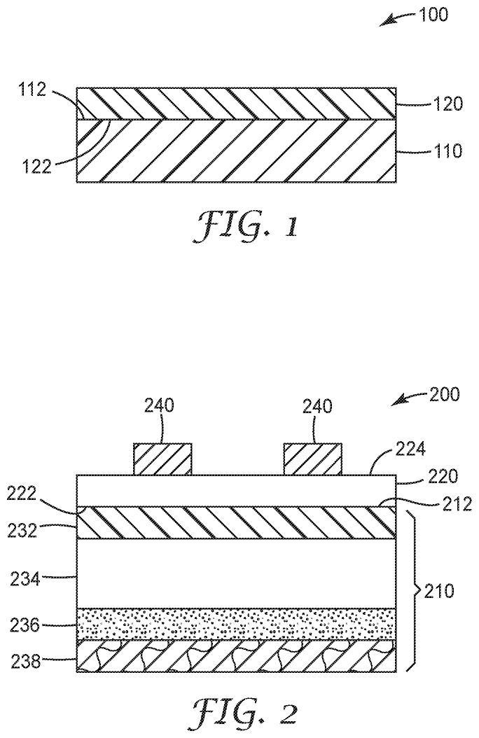

Article 100, according to some embodiments of the present disclosure, is illustrated in FIG. 1. Article 100 includes substrate 110 and coating 120. As shown, first surface 122 of coating 120 is directly bonded to first surface 112 of substrate 110. In some embodiments, the coating may be indirectly bonded to the substrate through one or more intermediate layers, e.g., a primer layer.

Generally, the composition of substrate 110 is not particularly limited. Both single layer, and multilayer substrates may be used. In some embodiments, first surface 112 of substrate 110 comprises a polymeric film, including e.g., a polyester, polyolefin, polycarbonate, or a polyurethane substrate. In some embodiments, first surface 112 of substrate 110 may comprise a metal including, e.g., an aluminum, iron, chrome, or steel layer.

Retroreflective article 200, according to some embodiments of the present disclosure, is illustrated in FIG. 2. Retroreflective article 200 includes substrate 210 and coating 220. Substrate 210 comprises at least retroreflective layer 234, and optionally one or more of protective layer 232, adhesive layer 236, and release liner 238. In some embodiments, additional layers may also be included. As shown, first surface 222 of coating 220 is directly bonded to protective layer 232 at first surface 212 of substrate 210. In some embodiments, the coating may be indirectly bonded to the substrate through one or more intermediate layers, e.g., a primer layer. In embodiments that do not include a protective layer, coating 220 is bonded (directly or indirectly) to an outer surface layer of the substrate.

In some embodiments, the protective layer is a coating or film, e.g., a polymeric coating or film. In some embodiments, the protective layer is transparent or translucent polymeric film. Generally, any polymeric film may be used including, e.g., polyesters and polycarbonates.

Retroreflective layer 234 may comprise any known retroreflective substrate. As used herein, “retroreflective” refers to the attribute of reflecting an obliquely incident light ray in a direction antiparallel to its incident direction, or nearly so, such that it returns to the light source or the immediate vicinity thereof. As used herein, “reflect” and “reflective” refer to any combination of specular and diffuse reflection, but exclude retroreflection.

Exemplary retroreflective layers include microsphere-based sheeting and microstructured-based sheeting (e.g., cube corner sheeting). Microsphere-based sheeting, sometimes called “beaded” sheeting, employs a multitude of microspheres typically at least partially imbedded in a binder layer and having associated specular or diffuse reflecting materials (e.g., pigment particles, metal flakes, vapor coats) to retroreflect incident light. Microstructured-based sheeting comprises a body portion typically having a substantially planar front surface and a structured rear surface comprising a plurality of microstructured elements. For example, cube corner retroreflective sheeting comprises a plurality of cube corner elements with each cube corner element comprises three approximately mutually perpendicular optical faces.

A variety of retroreflective substrates suitable for use in the articles of the present disclosure are commercially available. Exemplary microsphere based sheetings include those available under the tradenames 3M SCOTCHLITE 9920 Silver Industrial Wash Fabric and 3M PRECLEAR REFLECTIVE LICENSE PLATE SHEETING Series 4790 from 3M Company, St. Paul, Minn., U.S.A. Exemplary microstructure based sheetings include those available under the tradenames 3M DG3 DIAMOND GRADE Reflective sheeting and 3M ADVANCED ENGINEER GRADE Prismatic Sheeting from 3M Company.

Retroreflective article also includes ink 240 bonded to second surface 224 of coating 220. Generally, any ink may be used including solvent-based, water-based, and 100% solids inks. In some embodiments, cured ink, e.g., inks cured thermally or with actinic radiation such as ultra-violet light cured inks. The ink may be applied using conventional means such as screen printing and digital printing (e.g., thermal transfer printing).

Articles and retroreflective articles of the present disclosure may include signs (e.g., traffic signs), license plates, stickers, labels, and the like.

Various modifications and alterations of this invention will become apparent to those skilled in the art without departing from the scope and spirit of this invention.

1. A coating comprising an amino-functional silsesquioxane having amino-functional repeat units and non-functional repeat units, wherein the non-functional repeat units comprise non-functional groups selected from the group consisting of alkyl-groups and aryl-groups consisting of hydrogen and carbon.

2. The coating of claim 1, wherein the amino-functional silsesquioxane is the hydrolyzed product of at least one amino-functional, hydrolysable silane according to formula:
R_{AM}—Si—(R)₃
and at least one non-functional, hydrolysable silane according to formula:
R_{NF}—Si—(R)₃
wherein:
R_{AM} is an amino-functional group; and
R_{NF} is a non-functional group selected from the group consisting of alkyl-groups and aryl-groups consisting of hydrogen and carbon; and
each R is, independently, a hydroxyl group or a hydrolysable group.

3. The coating of claim 2, wherein at least one amino-functional group is an aminoalkyl-group.

4. The coating of claim 2, wherein at least one amino-functional, hydrolysable silane is an aminoalkyltrihydroxy silane or an aminoalkyltrialkoxy silane.

5. The coating of claim 4, wherein the at least one amino-functional, hydrolysable silane is selected from the group consisting of aminopropylsilanetriol, aminopropyltrimethoxysilane, aminopropyltriethoxysilane, and combinations thereof.

6. The coating of claim 2, wherein at least one amino-functional group is an aminoalkylaminoalkyl-group.

7. The coating of claim 6, wherein at least one amino-functional, hydrolysable silane is selected from the group consisting of aminopropylaminoethyltrimethoxysilane, aminopropylaminoethyltriethoxysilane, aminoethylaminopropyltrimethoxysilane, aminoethylaminopropyltriethoxysilane, and combinations thereof.

8. The coating according to claim 2, wherein the non-functional, hydrolysable silane is selected from the group consisting of an alkyltrihydroxy silane, an akyltrialkoxy silane, an aryltrihydroxy silane, an aryltrialkoxy silane, and combinations thereof.

9. The coating of claim 8, wherein the non-functional silane is selected from the group consisting of ethyltrialkoxy silane, phenyltrialkoxy silane, and combinations thereof.

10. The coating according to claim 2, wherein a ratio MR_{NF} is defined as MR_{NF}=M_{NF}/(M_{NF}+M_{AM}), where M_{NF} moles of the nonfunctional silane(s) and M_{AM} is the moles of amino-functional silane(s); and wherein MR_{NF} is between 0.05 and 0.5, inclusive.

11. The coating of claim 10, wherein MR_{NF} is no greater than 0.4.

12. The coating of claim 10, wherein MR_{NF} is no greater than 0.2.

13. The coating of claim 10, wherein MR_{NF} is at least 0.07.

14. The coating according to claim 1, further comprising a non-ionic surfactant.

15. An article comprising a substrate and the coating according to claim 1 bonded to a surface of the substrate.

16. The article of claim 15, wherein the substrate comprises a retroreflective sheeting.

17. The article of claim 15, further comprising an ink bonded to the coating.
